(19) United States
(12) Patent Application Publication
(10) Pub. No.: US 2017/0174430 A1
(43) Pub. Date: Jun. 22, 2017

(54) SELF-DUMPING DUMPSTER

(71) Applicant: Martin Perry HEARD, Lubbock, TX (US)

(72) Inventor: Martin Perry HEARD, Lubbock, TX (US)

(21) Appl. No.: 15/383,380

(22) Filed: Dec. 19, 2016

Related U.S. Application Data
(60) Provisional application No. 62/271,178, filed on Dec. 22, 2015.

(51) Int. Cl. B65F 3/26

(52) U.S. Cl. CPC B65F 3/26; B65F 2003/006

(57) ABSTRACT

The present invention relates to a self-dumping dumpster and trailer assembly particularly suitable for hauling refuse and yard waste.

### CROSS-REFERENCE TO RELATED APPLICATION

This application claims the benefit of priority to U.S. Provisional Application No. 62/271,178, filed Dec. 22, 2015. The disclosure of the priority application is hereby incorporated in its entirety by reference.

The present invention relates to a self-dumping dumpster and trailer assembly particularly suitable for hauling refuse and yard waste.

### BACKGROUND

The removal of refuse and yard waste has frequently been accomplished through a system whereby small containers hold the refuse or waste at a residential location until the contents of those containers can be transferred to a vehicle having a larger container, i.e., dump truck, that can then transfer the refuse or waste to a dump or waste transfer facility.

One problem that may arise, particularly in rural settings, is that there are insufficient residents to justify a waste removal service. There remains a need for a convenient waste receptacle that can be conveniently transport waste or refuse to a dump or waste transfer facility.

### SUMMARY OF THE INVENTION

The present invention involves a trailer dumpster including a dumpster body that is rotatably attached to a trailer. The trailer dumpster includes a dumpster body having a front wall, a first side wall, and a second side wall. There is a first latch portion attached to the front wall. The trailer comprises an axle, two or more tires connected with the axle, a second latch portion and a front hitch. The dumpster body is rotatably attached to the trailer assembly such that the dumpster body can be rotated toward the rear of the trailer assembly allowing contents to be more easily removed through the rear of the dumpster body and the first latch portion and second latch portion can be secured to the trailer when dumpster body is aligned with the trailer.

The trailer dumpster also may include a first lid attached to the second side wall through a hinge. The rear lid may be attached through an upper hinge. In a preferred embodiment, the second side wall is elevated relative to the first side wall such that the first lid rests at an angle. In another embodiment, the second side wall and the first side wall are equal height such that the first lid rests flat. The dumpster body is preferably rectangular and rotatably attached to the trailer proximate the axle. In one embodiment the dumpster body is rotatably attached to the trailer at a region above the axle.

### BRIEF DESCRIPTION OF THE DRAWING

FIG. 1 is a side and front view of the self-dumping dumpster according to an aspect of the present invention.

FIG. 2 is a side and back view of the self-dumping dumpster according to an aspect of the present invention.

### DETAILED DESCRIPTION OF THE PREFERRED EMBODIMENTS

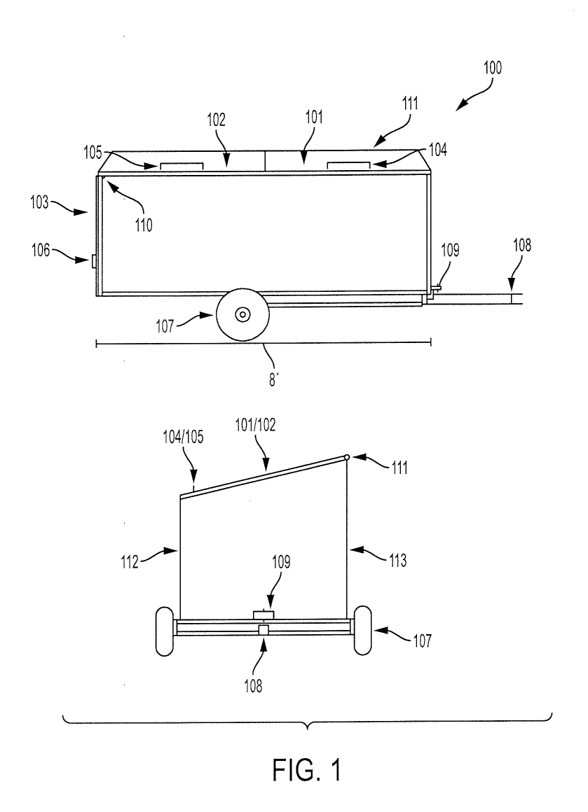

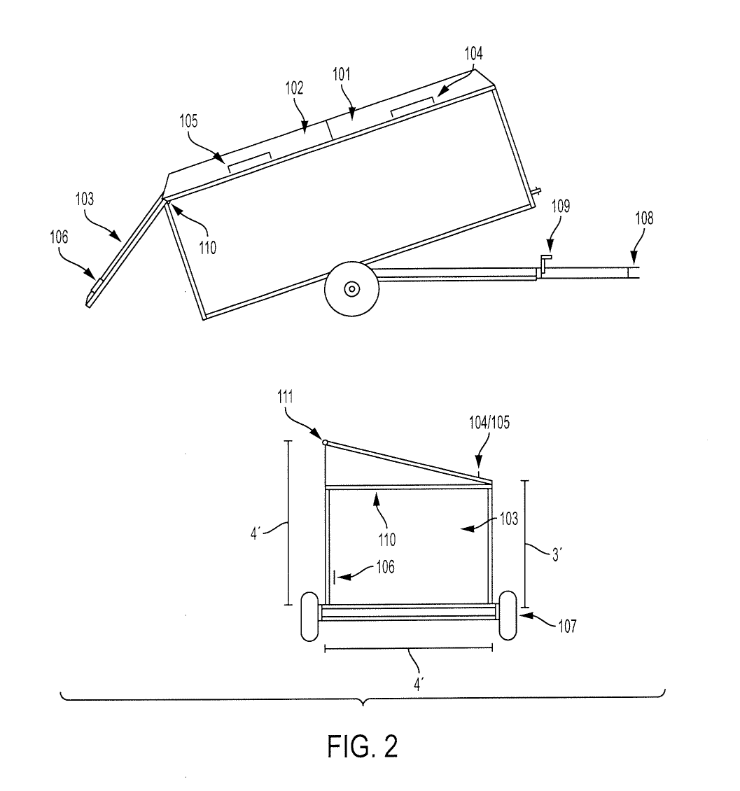

The present invention relates to a self-dumping trailer dumpster 100 a preferred embodiment of which is illustrated in FIGS. 1 and 2. The dumpster is preferably two to eight cubic yards in capacity, preferably about 4 cubic yards. The dumpster includes a main container with one or two upper lids 101/102. The dumpster is secured to a trailer assembly including a hitch 108 and wheels 107. The front end of the dumpster is secured to the trailer using a releasable latch 109. The dumpster body is secured to the trailer body at its mid-section through a rotatable joint that allows the dumpster from end to be elevated relative to its rear end while the trailer remains hitched to a vehicle through hitch 108.

The upper lids 101/102 are preferably inclined with a front portion that sits lower than the elevated rear portion. The angle of incline is defined by the relative height of the front/side panel 112 compared to the rear side panel 113. The upper lid(s) are secured to the rear/side panel 113 through hinge 111. The upper lid(s) include one or more handles 104/105. Refuse is generally placed into the dumpster by a user by opening the upper lid(s) 101/102. In one aspect, the upper lids include a stand for keeping the lid in a semi-opened state. The hinge 111 attaching the lid(s) 101/102 to the rear/side panel 112 allow for complete range of motion so that the lid(s) may be opened to the point of resting parallel or near parallel to the rear side panel 112.

The dumpster also includes a rear lid 103 that is attached to the dumpster through hinge 110. The rear lid may contain a handle 106. The rear lid 103 swings open in operation to permit refuse to be more easily removed through the rear of the dumpsters. Preferably, when refuse is to be removed from the dumpster, latch 109 is opened, the dumpster body tips toward the rear, lid 103 is opened, and refuse is removed from the rear of the dumpster. When the dumping operation is complete, the dumpster body is rotated back to a level position and the latch 109 is secured.

While various embodiments of the invention have been described in terms of various specific embodiments, those skilled in the art will appreciate and recognize that the invention can be practiced with modifications within the spirit and scope of the claims.

1. A trailer dumpster comprising:
a dumpster body having a front wall, a first side wall, and a second side wall;
a first latch portion attached to the front wall;
a trailer comprising an axle, two or more tires connected with the axle, a second latch portion and a front hitch, wherein the dumpster body is rotatably attached to the trailer assembly such that the dumpster body can be rotated toward the rear of the trailer assembly allowing contents to be more easily removed through the rear of the dumpster body and the first latch portion and second latch portion can be secured to the trailer when dumpster body is aligned with the trailer.

2. The trailer dumpster of claim 1, further comprising a first lid attached to the second side wall through a hinge.

3. The trailer dumpster of claim 1, further comprising a rear lid attached to an upper hinge.

4. The trailer dumpster of claim 1, wherein the second side wall is elevated relative to the first side wall such that the first lid rests at an angle.

5. The trailer dumpster of claim 1, wherein the second side wall and the first side wall are equal height such that the first lid rests flat.

6. The trailer dumpster of claim 1, wherein dumpster body is rectangular.

7. The trailer dumpster of claim 1, wherein dumpster body is rotatably attached to the trailer proximate the axle.

8. The trailer dumpster of claim 1, wherein dumpster body is rotatably attached to the trailer at a region above the axle.
